(19) United States
(12) Patent Application Publication
(10) Pub. No.: US 2017/0116389 A1
(43) Pub. Date: Apr. 27, 2017

(54) PATIENT MEDICATION ADHERENCE AND INTERVENTION USING TRAJECTORY PATTERNS

(71) Applicants: Olga Matlin, Buffalo Grove, IL (US); William Shrank, Chevy Chase, MD (US); Alla Stavnitser, Chicago, IL (US); Steven Kymes, St. Louis, MO (US)

(72) Inventors: Olga Matlin, Buffalo Grove, IL (US); William Shrank, Chevy Chase, MD (US); Alla Stavnitser, Chicago, IL (US); Steven Kymes, St. Louis, MO (US)

(21) Appl. No.: 14/919,996

(22) Filed: Oct. 22, 2015

(51) Int. Cl. G06F 19/00

(52) U.S. Cl. CPC G06F 19/3456

(57) ABSTRACT

A type of intervention is selected for a patient who is not adhering to a prescribed treatment schedule by comparing the first months of the patient's adherence to predetermined trajectories of adherence to thereby predict the patient's adherence and select the intervention based thereon.

### TECHNICAL FIELD

Embodiments of the present invention relate generally to medication adherence and patient intervention and, in particular, to the use of predictive modeling to select intervention type and timing.

### BACKGROUND

Patients are sometimes prescribed a daily, semi-daily, or weekly schedule for taking medication on a long-term or otherwise ongoing basis. While some of these patients may adhere faithfully to their prescribed schedule, not all of them do, and those that do not may taper off or even completely cease taking their medication. If these non-adherent patients can be identified, intervention by a third party (such as by a telephone call, SMS text message, email, or in-person visit) may encourage them to start taking their medication again and adhere to the prescribed schedule.

Existing methods of identification of non-adherent patients are less than ideal, however. These methods of predicting medication adherence focus on a binary prediction measure: a patient is categorized as adherent or not if the patient is deemed to possess their medication greater than a threshold ratio of time (e.g., greater than 80% of the time). This classification, however, collapses a broad spectrum of adherence behaviors into an overly simplistic dichotomy that misses important distinctions among unique behaviors. A patient may be consistently 79% adherent, for example, yet be categorized as non-adherent given an 80% threshold; another patient may be 100% adherent some of the time and 0% adherent at other times yet be categorized as adherent if the average adherence is 81%.

These misclassifications of patient adherence may lead to missed opportunities for interventions or make interventions ineffective or wasteful, resulting in adverse clinical outcomes and increased healthcare costs. Some patients who lie above the simple threshold may, in fact, exhibit periods of non-adherence and may respond positively to intervention. Other patients who were previously adherent may abruptly become non-adherent and too much time may elapse before their adherence falls below the threshold; by the time the threshold triggers, the intervention may not be as effective as it would have been if it were sooner. Still other patients may exhibit such low compliance (or a trend toward very low compliance) that an intervention would be ineffective and therefore a waste of resources. And, especially, patients with the same or similar adherence rates may in fact exhibit vastly different adherence behaviors and may respond to different types of interventions with different rates of success; existing methods of measuring adherence provide no means of identifying these different adherence behaviors. A need therefore exists for a system and method for identifying adherence behaviors and trends and providing improved interventions.

### SUMMARY

Embodiments of the present invention include systems and methods for identifying patients who are most likely to be in need of intervention, as well as when and how the intervention is best implemented to thereby increase intervention effectiveness and efficiency. In various embodiments, a set of training data contains historical information about the adherence of a number of patients over a period of time (e.g., one year). The training data may be analyzed to create a number of “trajectories”—curves that each approximate adherence over time for a different subset of the patients—using what is known as “group-based trajectory modeling.” A first trajectory that remains consistently high throughout the period of time may best approximate the adherence profile of a first group of consistently adherent patients, for example, while a second trajectory that begins high but falls during the time period may best approximate the adherence profile of a second group of patients. The adherence habits of current patients may then be compared to the trajectories to predict the long-term adherence of those patients; three months of adherence data may, for example, be used to predict how well the patient will adhere at the end of twelve months. Once an adherence pattern is identified, an intervention may be selected based thereon to maximize the chance that non-adherent patients return to their prescribed schedules of taking medication.

In one aspect, a system for detecting that a patient is not adhering to a prescribed medication and for selecting an intervention based on the detection includes a non-volatile computer memory for storing a plurality of patient-adherence trajectories derived from a set of training data comprising patient adherence to a medication over the course of at least a year; a network interface for transmitting and receiving data over a computer network; and a computer processor for executing software instructions for receiving, via the network interface, adherence data representing patient adherence to the prescribed medication for each of a plurality of months; selecting, using the computer processor, one of the plurality of patient-adherence trajectories that most closely matches the received adherence data; predicting, using the computer processor, a patient adherence based on the selected patient-adherence trajectory; and selecting, using the computer processor, one of a plurality of intervention types based on the determined patient adherence.

The adherence data representing patient adherence may include three months of patient-adherence data. The adherence data representing patient adherence may include a 0 for a non-adherent month and a 1 for a compliant month and/or include eight categories of three 0 s or 1 s. Selecting one of the plurality of patient-adherence trajectories may include matching a pattern of 0s and 1s in the adherence data with a most-frequently occurring matching pattern in the plurality of patent-adherence trajectories. The plurality of patient-adherence trajectories may include six trajectories. At least one of the six trajectories may represent an adherence rate that first decreases and then increases. The patient adherence may be worst adherence and/or decrease-then-increase adherence and the selected intervention type may be no intervention. The patient adherence may be falling adherence and the selected intervention type may be intervention at a future point in time. The future point in time may correspond to the adherence rate falling below a threshold and/or a rate of change of the adherence rate increasing past a threshold.

In another aspect, a method for detecting that a patient is not adhering to a prescribed medication and for selecting an intervention based on the detection includes receiving, via a network interface, adherence data representing patient adherence to the prescribed medication for each of a plurality of months; selecting, using the computer processor, one of the plurality of patient-adherence trajectories derived from a set of training data comprising patient adherence to a medication over the course of at least a year that most closely matches the received adherence data; predicting, using the computer processor, a patient adherence based on the selected patient-adherence trajectory; and selecting, using the computer processor, one of a plurality of intervention types based on the determined patient adherence.

The adherence data representing patient adherence may include three months of patient-adherence data and/or a 0 for a non-adherent month and a 1 for a compliant month. Selecting one of the plurality of patient-adherence trajectories may include matching a pattern of 0s and 1s in the adherence data with a most-frequently occurring matching pattern in the plurality of patent-adherence trajectories. The plurality of patient-adherence trajectories may include six trajectories; at least one of the six trajectories may represent an adherence rate that first decreases and then increases. The patient adherence may be decrease-then-increase adherence and the selected intervention type may be no intervention; the patient adherence may be falling adherence and the selected intervention type may be intervention at a future point in time.

These and other objects, along with advantages and features of the present invention herein disclosed, will become more apparent through reference to the following description, the accompanying drawings, and the claims. Furthermore, it is to be understood that the features of the various embodiments described herein are not mutually exclusive and can exist in various combinations and permutations.

### BRIEF DESCRIPTION OF THE DRAWINGS

In the drawings, like reference characters generally refer to the same parts throughout the different views. In the following description, various embodiments of the present invention are described with reference to the following drawings, in which:

FIG. 1 illustrates a method for creating group-based trajectories from a set of training data and defining a set of interventions in accordance with an embodiment of the invention;

FIG. 2 illustrates a chart of exemplary trajectories in accordance with an embodiment of the invention;

FIG. 3 illustrates a method for defining an intervention based on matching received training data to a group-based trajectory in accordance with an embodiment of the invention; and

FIG. 4 illustrates a system for selecting an intervention in accordance with an embodiment of the invention.

### DETAILED DESCRIPTION

Group-based trajectory modeling provides a rich source of targeting information for decision-makers to target adherence interventions by grouping patients according to their prescription-filling patterns over time. Patients may fall into four primary trajectories or classifications: (1) patients who are optimally adherent to a medication schedule at the onset of treatment and remain so throughout the treatment; (2) patients whose adherence quickly drops off following their first prescription fill and do not fill another prescription (3) patients whose likelihood of filling a prescription drops over time and eventually become non-adherent; and (4) patients whose likelihood of filling a prescription drops over time but who eventually return to being adherent within a certain amount of time (e.g., a year). The present invention is not limited to only these trajectories, however, and the modeling of any number of trajectories is within the scope of the present invention. Classification of patients into these categories may be made based upon their prescription filling patterns over the first months (e.g., the first three or four months) of a medication regimen. Patients who fall into the first category may not benefit from an adherence intervention because they are already adherent; patients who fall into the other categories, however, may be considered for an intervention depending on evidence of success associated with each category's adherence trajectory.

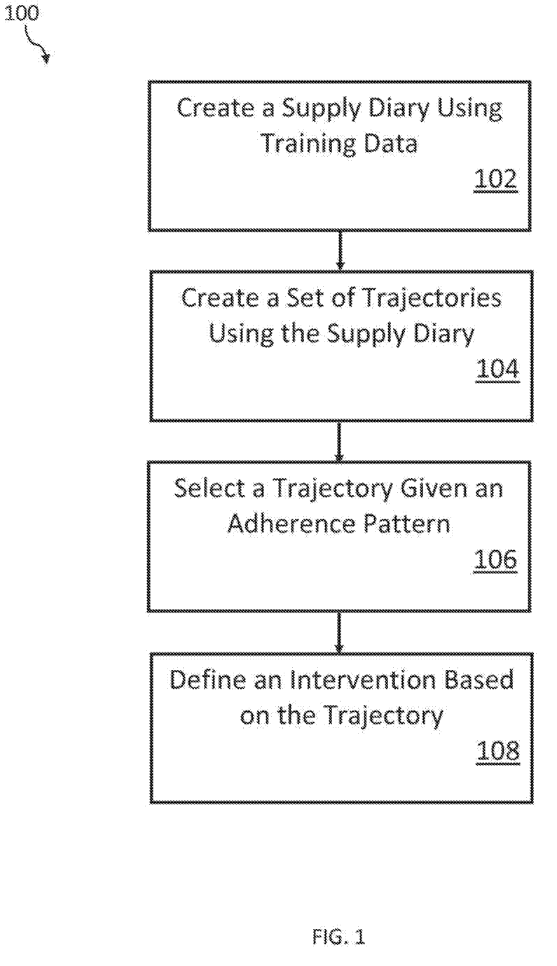

In various embodiments of the present invention and with reference to FIG. 1, a “supply diary” is created (102) using a set of training data, a set of trajectories is created (104) using the supply diary, adherence patterns of current patients are applied (106) to the trajectories to select a trajectory and thereby predict the future adherence of the current patients, and an intervention is selected (108) for the patients based on the prediction. Each of these steps is explained in greater detail below.

In a first step (102), a supply diary is created using a set of training data. The training data includes historical adherence information for a plurality of patients over a period of time (for example, one year). In one embodiment, the patients comprise a demographic similar to that of the current patients for whom interventions are to be made (as explained in greater detail below); the type of medication prescribed in the training data may also be the same or similar to the medication prescribed to the current patients. For example, both the training data and current patients may be prescribed on statins to treat high cholesterol; the similarity in prescribed medication may improve the predicted adherence of the current patients. The present invention is not limited to using the same medication for both training and prediction, however, and the use of any type or combination of medication is within its scope. The training data may include, for example, adherence information from any number of patients or medications and may span any length of time. The patient adherence information may be collected from patients who were “new” to the medication schedule (wherein “new” is defined as patients who have not taken the medication for at least, for example, six months prior to the date of initial collection) or, in other embodiments, from any other patients.

The supply diary describes an adherence pattern of a patient over time. In one embodiment, if a patient is adherent to a medication during a month, he or she is assigned a value of 1 for that month; if the patient is not adherent, he or she is assigned a 0. The supply diary thus comprises a sequence of 0s and 1s for each patient; if the training data includes adherence information that spans a year, a sequence of twelve 0s and 1s are assigned to each patient. The patient may be considered adherent for a given month if he or she possesses a threshold level of medication during that month; the threshold may be, for example, 80%, though any threshold is within the scope of the present invention. Possession of the medication for a given month may be determined by detection of the patient picking up the medication at a pharmacy, by voluntary reporting by the patient, by medical testing of the patient, by patient survey, or by any other means. If patient adherence is known more precisely, the patient may be assigned a number between 0 and 1 for that month. For example, if it is known that the patient complied with his or her prescribed schedule for 20 days in a 30-day month, he or she may be assigned 0.67 for that month.

In a second step (104), a set of trajectories is created using the supply diary. In various embodiments, group-based trajectory modeling identifies underlying latent variable(s) that measures trends over time and may thus be used to group the patients into trajectories; the trajectories represent categories of adherence. Any type of distribution being modeled, any number of expected trajectories, and any trajectory shape (e.g., linear, quadratic, or cubic) is within the scope of the present invention. In one embodiment, six trajectories are estimated. One of skill in the art will understand that the methods of group-based trajectory modeling are well-known and that it, any variation thereof, and the use of similar techniques are within the scope of the present invention. More information about group-based trajectory modeling may be found in, for example, “A SAS Procedure Based on Mixture Models for Estimating Developmental Trajectories” by Jones et al., SOCIOLOGICAL METHODS & RESEARCH, Vol. 29 No. 3, February 2001 374-393, the disclosure of which is hereby incorporated by reference herein in its entirety.

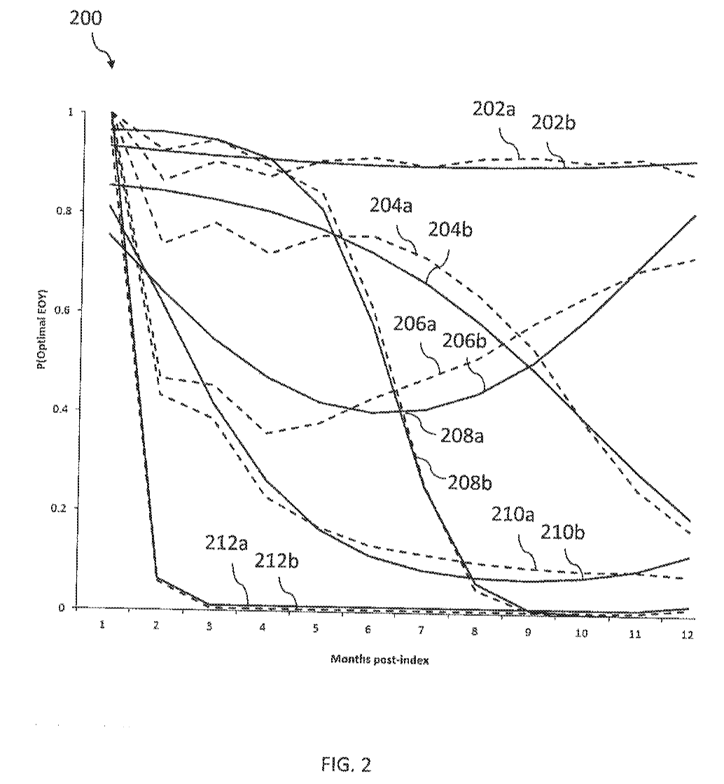

FIG. 2 illustrates a chart 200 that includes six trajectories 202a,b-212a,b generated from a supply diary; in this example, twelve months of adherence information after initiation of statin therapy is shown, but similar trajectories may be generated using any span of time and any medication. The trajectories 202a-212a represent the estimated monthly rates of adherence, and the trajectories 202b-212b represent the averages thereof. Each point on each trajectory represents the probability that a patient assigned to that particular trajectory will be adherent to their medical therapy during that month. For example, in month 7, trajectory 204a,b has a value of approximately 0.6, which indicates that a patient assigned to that trajectory has an approximate 60% probability of being adherent during that month. The trajectories 202a,b-212a,b demonstrate that there are distinct patterns of adherence following medication initiation. Patients assigned to trajectory 202a,b, which in this example account for 50% of all patients, are the most likely to adhere to their prescribed schedules and have an adherence probability exceeding 90% in each month. At the other end of the spectrum, patients assigned to trajectory 212a,b (accounting for approximately 12% of all patients) have the worst adherence; less than 10% of these patients fill their second prescription, and none fill a third. Trajectories 204a,b, 208a,b, and 210a,b represent different rates of decline in adherence over time, and represent 13%, 9% and 5% of all patients, respectively. Finally, patients assigned to trajectory 206a,b (representing approximately 11% of all patients) decline in adherence in the first half of the year but recover in adherence later in the year.

Once the trajectories have been generated as described above, in a third step (106), adherence patterns of current patients are applied to the trajectories to select a trajectory for each patient to thereby predict the future adherence of the current patients. To begin, in some embodiments, the training data is re-examined to determine the odds that, given a first three months of historical adherence data, which patient in the training data set will end up in which trajectory. For example, it may be determined if that a patient in the training data set is non-compliant for the first three months (i.e., the first three entries in their supply diary are 000), that patient has a 3% chance of ultimately behaving in accordance with trajectory 208a,b, a 17% chance of trajectory 210a,b, and an 80% chance of trajectory 212a,b. This determination tracks expectations, because if a patient is non-adherent for the first three months, he or she will likely continue to be non-adherent and behave in accordance with the least adherent trajectory, 212a,b. This analysis may be extended for the rest of the adherence patterns for the first three months (001; 010; 011; 100; 101; 110; and 111); the results are summarized below in Table 1.

TABLE 1
Trajectory Probability Given Initial 90-Day Pattern

| 90-day | Trajectory | | | | | |
|---|---|---|---|---|---|---|
| pattern | 102a,b | 104a,b | 106a,b | 108a,b | 110a,b | 112a,b |
| 000 | — | — | — | 3% | 17% | 80% |
| 010 | 5% | 5% | 10% | 10% | 50% | 20% |
| 001 | — | 5% | 5% | 40% | 20% | 30% |
| 011 | 5% | 10% | 25% | 28% | 17% | 15% |
| 100 | 15% | 15% | 30% | 20% | 15% | 5% |
| 101 | 10% | 10% | 40% | 25% | 15% | — |
| 110 | 25% | 50% | 10% | 10% | 5% | — |
| 111 | 60% | 20% | 10% | 5% | 5% | — |

Given the data of Table 1, a most-likely final trajectory may be predicted for each initial 90-day pattern by selecting the trajectory having the highest probability for each pattern. In the example given above for the initial 90-day pattern 000, trajectory 212a,b is selected because it has the highest probability (80%); the rest of the trajectories may similarly be chosen for the rest of the initial 90-day patterns. Table 2, below, maps all of the initial 90-day patterns to final trajectories.

TABLE 2
Initial 90-Day Pattern Mapping to Trajectory

| Initial 90-day pattern | Most Likely Final Trajectory |
|---|---|
| 000 | 112a,b |
| 010 | 110a,b |
| 001 | 108a,b |
| 011 | 108a,b |
| 100 | 106a,b |
| 101 | 106a,b |
| 110 | 104a,b |
| 111 | 102a,b |

Given the mapping shown above in Table 2, the most likely final trajectory of current patients may be estimated after only three months of adherence data is collected by applying the collected data to the table. The present invention is not limited, however, to predicting a final trajectory based on three months of adherence data, and any number of days, weeks, or months of adherence data may be used to make a prediction. One of skill in the art will understand that the above process to create the mapping of Table 2 may be modified to map two, four, or any other number of months, weeks, or days.

The accuracy of the assignments of Table 2 may be evaluated using the c-statistic, which compares the actual pattern of adherence to the predicted for each member. The c-statistic is an approximation of the accuracy of a metric in classification of a randomly selected case from the target population. In the case of the adherence trajectories discussed herein, there are two classification tasks that may be considered: (1) the accuracy of each twelve-month trajectory 202a,b-212a,b in predicting the twelve-month adherence of training-data patients classified in each trajectory 202a,b-212a,b (i.e., how accurately the trajectories 202a,b-212a,b actually model patient behavior) and (b) the accuracy of assigning training-data patients to a trajectory 202a,b-212a,b given only the first three or four months of adherence data (i.e., how accurate the predictions of patient adherence actually are).

Applying the trajectories 202a,b-212a,b to the source data to determine the accuracy of the twelve-month trajectories yields a c-statistic of 0.91. The c-statistic of 0.91 for this relationship indicates that the trajectories are very accurate in predicting monthly adherence. The accuracy of using three or four months of initial data to classifying a patient into the correct trajectory (as defined by the trajectory that would have been selected had the full twelve months of data been used) may be similarly computed using the c-statistic. In one embodiment, the c-statistic is used to determine the accuracy of classifying patients into two groups: the most-adherent group and the least-adherent group—two groups are chosen because the c-statistic is most efficient in measuring the accuracy of classification into dichotomous categories. It was found that the c-statistic is 0.78 and 0.83 for categorizing the most-adherent patients given three and four months of adherence data, respectively; the c-statistic is 0.91 and 0.94 for categorizing the least-adherent patients given three and four months of adherence data, respectively.

Once a trajectory has been chosen, in a fourth step (108), an intervention is selected based on the trajectory. The type of intervention, the timing of the intervention, and the duration of the intervention may be selected based on the predicted adherence trajectory or type. If a patient is predicted to be very adherent (e.g., trajectory 202a,b) or very non-adherent (e.g., trajectory 212a,b) no intervention may be selected or scheduled. If the patent is predicted to have decreasing adherence (e.g., trajectories 204a,b, 208a,b, or 210a,b), one or more intervening phone calls or messages may be scheduled immediately or at one or more points in the future. The interventions may be scheduled before, during, or after a period of highest decrease in predicted adherence; this point may occur at different points in time for different trajectories. If the predicted trajectory first decreases and then increases (e.g., trajectory 206a,b), the intervention may be scheduled during the decreasing portion, at the lowest point, or not at all. In various embodiments, one type of intervention (e.g., phone calls, text messages, or emails) is used throughout the intervention process; in other embodiments, a first, less-intrusive type of intervention (e.g., text messages or emails) is used at first and a more-intrusive type of intervention (e.g., phone calls) is used after.

In some embodiments, additional adherence data is collected after the first prediction is computed (at, for example, three or four months after the beginning of the medication schedule). This additional data may be collected monthly, semi-monthly, or at any other rate; the additional data may also or instead be collected at random times. The additional data collected for a patient may be compared against the predicted trajectory of that patient to either verify that the correct trajectory was selected or to select a different, better-fitting trajectory.

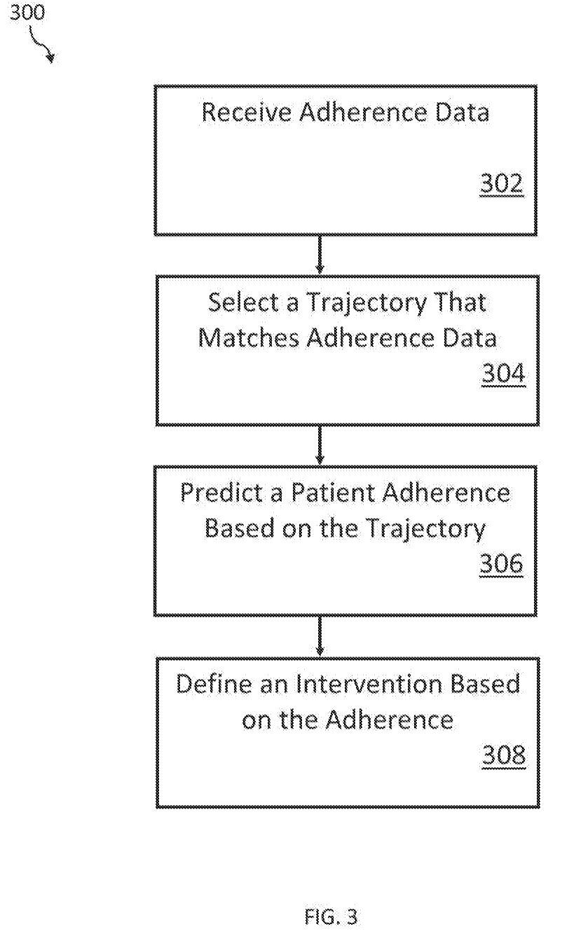

FIG. 3 illustrates a method 300 in accordance with another embodiment of the present invention. In a first step, adherence data for the initial period of 3 months, or an initial period of another length, is received (302). As explained in greater detail above, the adherence data may be a series of 0s and 1s that signify months in which a patient is or is not adherence and may correspond to three months of data. A trajectory that matches the adherence data is selected (304); as explained above, a mapping may be constructed between every permutation of three months of adherence and corresponding most-likely twelve-month trajectories, and the trajectory may be selected by applying this mapping to the adherence data. A patient adherence may be predicted (306) based on the trajectory (e.g., consistently adherent, consistently non-adherent, decreasing adherence, etc.) and an intervention may be selected (308) based on the adherence.

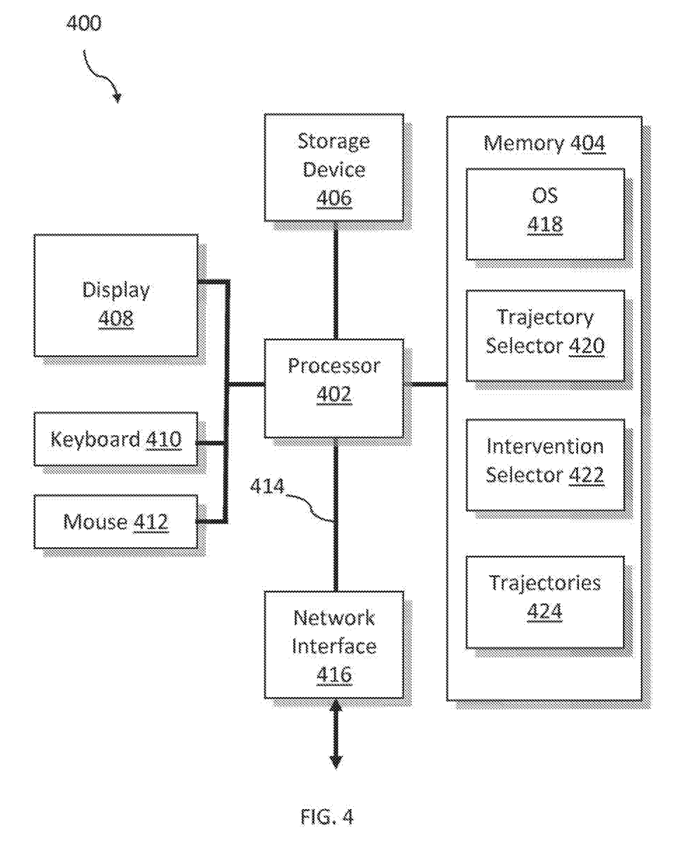

FIG. 4 is a simplified block diagram of a suitably programmed general-purpose computer 400 implementing embodiments of the present invention. The computer 400 includes a processor 402 having one or more central processing units (CPUs), volatile and/or non-volatile main memory 204 (e.g., RAM, ROM, or flash memory), one or more mass storage devices 206 (e.g., hard disks, or removable media such as CDs, DVDs, USB flash drives, etc. and associated media drivers), a display device 408 (e.g., a liquid-crystal display (LCD) monitor), user-input devices such as a keyboard 410 and a mouse 412, and one or more buses 414 (e.g., a single system bus shared between all components, or separate memory and peripheral buses) that facilitate communication between these components. A network interface 416 (e.g., a Wi-Fi or ETHERNET port) may be used to connect the computer 400 to the Internet or other network.

The main memory 404 may be used to store instructions to be executed by the processor 402, conceptually illustrated as a group of modules. These modules generally include an operating system 418 (e.g., a Microsoft WINDOWS, Linux, or APPLE OS X operating system) that directs the execution of low-level, basic system functions (such as memory allocation, file management, and the operation of mass storage devices), as well as higher-level software applications, such as a trajectory selector 420 and an interference selector 422. The various modules may be programmed in any suitable programming language, including, without limitation high-level languages such as C, C++, Java, Perl, Python, or Ruby or low-level assembly languages. The memory 404 may further store input and/or output data associated with execution of the instructions (including, e.g., trajectory data 224) as well as additional information used by the various software applications.

The computer 400 is described herein with reference to particular blocks, but this description is not intended to limit the invention to a particular physical arrangement of distinct component parts. The computer 400 is an illustrative example; variations and modifications are possible. Computers may be implemented in a variety of form factors, including server systems, desktop systems, laptop systems, tablets, smartphones or personal digital assistants, and so on. A particular implementation may include other functionality not described herein, e.g., wired and/or wireless network interfaces, media playing and/or recording capability, etc. In some embodiments, one or more cameras may be built into the computer rather than being supplied as separate components. Further, the computer processor may be a general-purpose microprocessor, but depending on implementation can alternatively be, e.g., a microcontroller, peripheral integrated circuit element, a customer-specific integrated circuit (“CSIC”), an application-specific integrated circuit (“ASIC”), a logic circuit, a digital signal processor (“DSP”), a programmable logic device such as a field-programmable gate array (“FPGA”), a programmable logic device (“PLD”), a programmable logic array (“PLA”), smart chip, or other device or arrangement of devices.

It should also be noted that embodiments of the present invention may be provided as one or more computer-readable programs embodied on or in one or more articles of manufacture. The article of manufacture may be any suitable hardware apparatus, such as, for example, a floppy disk, a hard disk, a CD ROM, a CD-RW, a CD-R, a DVD ROM, a DVD-RW, a DVD-R, a flash memory card, a PROM, a RAM, a ROM, or a magnetic tape. In general, the computer-readable programs may be implemented in any programming language. Some examples of languages that may be used include C, C++, or JAVA. The software programs may be further translated into machine language or virtual machine instructions and stored in a program file in that form. The program file may then be stored on or in one or more of the articles of manufacture.

Certain embodiments of the present invention were described above. It is, however, expressly noted that the present invention is not limited to those embodiments, but rather the intention is that additions and modifications to what was expressly described herein are also included within the scope of the invention. Moreover, it is to be understood that the features of the various embodiments described herein were not mutually exclusive and can exist in various combinations and permutations, even if such combinations or permutations were not made express herein, without departing from the spirit and scope of the invention. In fact, variations, modifications, and other implementations of what was described herein will occur to those of ordinary skill in the art without departing from the spirit and the scope of the invention. As such, the invention is not to be defined only by the preceding illustrative description.

What is claimed is:

1. A system for detecting that a patient is not adhering to a prescribed medication and for selecting an intervention based on the detection, the system comprising:
a non-volatile computer memory for storing a plurality of patient-adherence trajectories derived from a set of training data comprising patient adherence to a medication over the course of at least a year;
a network interface for transmitting and receiving data over a computer network; and
a computer processor for executing software instructions for:
i. receiving, via the network interface, adherence data representing patient adherence to the prescribed medication for each of a plurality of months;
ii. selecting, using the computer processor, one of the plurality of patient-adherence trajectories that most closely matches the received adherence data;
iii. predicting, using the computer processor, a patient adherence based on the selected patient-adherence trajectory; and
iv. selecting, using the computer processor, one of a plurality of intervention types based on the determined patient adherence.

2. The system of claim 1, wherein the adherence data representing patient adherence comprises three months of patient-adherence data.

3. The system of claim 1, wherein the adherence data representing patient adherence comprises a 0 for a non-adherent month and a 1 for a compliant month.

4. The system of claim 3, wherein the adherence data comprises eight categories of three 0s or 1s.

5. The system of claim 3, wherein selecting one of the plurality of patient-adherence trajectories comprises matching a pattern of 0s and is in the adherence data with a most-frequently occurring matching pattern in the plurality of patent-adherence trajectories.

6. The system of claim 1, wherein the plurality of patient-adherence trajectories comprises six trajectories.

7. The system of claim 6, wherein at least one of the six trajectories represents an adherence rate that first decreases and then increases.

8. The system of claim 1, wherein the patient adherence is worst adherence and the selected intervention type is no intervention.

9. The system of claim 1, wherein the patient adherence is decrease-then-increase adherence and the selected intervention type is no intervention.

10. The system of claim 1, wherein the patient adherence is falling adherence and the selected intervention type is intervention at a future point in time.

11. The system of claim 10, wherein the future point in time corresponds to the adherence rate falling below a threshold.

12. The system of claim 10, wherein the future point in time corresponds to a rate of change of the adherence rate increasing past a threshold.

13. A method for detecting that a patient is not adhering to a prescribed medication and for selecting an intervention based on the detection, the method comprising:
receiving, via a network interface, adherence data representing patient adherence to the prescribed medication for each of a plurality of months;
selecting, using the computer processor, one of the plurality of patient-adherence trajectories derived from a set of training data comprising patient adherence to a medication over the course of at least a year that most closely matches the received adherence data;
predicting, using the computer processor, a patient adherence based on the selected patient-adherence trajectory; and
selecting, using the computer processor, one of a plurality of intervention types based on the determined patient adherence.

14. The method of claim 13, wherein the adherence data representing patient adherence comprises three months of patient-adherence data.

15. The method of claim 13, wherein the adherence data representing patient adherence comprises a 0 for a non-adherent month and a 1 for a compliant month.

16. The method of claim 15, wherein selecting one of the plurality of patient-adherence trajectories comprises matching a pattern of 0s and is in the adherence data with a most-frequently occurring matching pattern in the plurality of patent-adherence trajectories.

17. The method of claim 13, wherein the plurality of patient-adherence trajectories comprises six trajectories.

18. The method of claim 17, wherein at least one of the six trajectories represents an adherence rate that first decreases and then increases.

19. The method of claim 13, wherein the patient adherence is decrease-then-increase adherence and the selected intervention type is no intervention.

20. The method of claim 13, wherein the patient adherence is falling adherence and the selected intervention type is intervention at a future point in time.
